(19) United States
(12) Patent Application Publication
(10) Pub. No.: US 2022/0382623 A1
(43) Pub. Date: Dec. 1, 2022

(54) INFORMATION PROCESSING SYSTEM, METHOD, AND APPARATUS

(71) Applicant: Hitachi, Ltd., Tokyo (JP)

(72) Inventor: Masaru YOSHIMACHI, Tokyo (JP)

(73) Assignee: Hitachi, Ltd., Tokyo (JP)

(21) Appl. No.: 17/681,087

(22) Filed: Feb. 25, 2022

(30) Foreign Application Priority Data
May 27, 2021 (JP) 2021-088864

(51) Int. Cl. G06F 11/07

(52) U.S. Cl. CPC G06F 11/0793; G06F 11/0721

(57) ABSTRACT

An information processing system, method, and apparatus reduces maintenance costs and management work and expedites countermeasures. A guide for a new event is selected based on information transmitted from the monitoring target node at which the new event has occurred; whether a countermeasure designated by the guide selected for the new event can be executed or not is judged; under this circumstance, past events having similarity to the new event which has occurred at the monitoring target node are identified; and if countermeasures against a specified last number of the past events among the identified past events have been successful and a countermeasure against the past event which is the latest and is more similar to the new event among the past events identified as the new event has been successful, it is judged that the countermeasure designated by the guide selected by the guide selection unit should be executed.

### TECHNICAL FIELD

The present invention relates to an information processing system, method, and apparatus and is suited for application to, for example, an information processing system that automatically executes a countermeasure(s) against an event which has occurred at monitoring target equipment.

### BACKGROUND ART

When an event such as an error occurs at equipment such as a server apparatus or a storage apparatus, event information including a message indicating the content of that event is output from the equipment. Conventionally, a countermeasure against the occurrence of such an event has been taken by searching a plurality of guides, which are prepared in advance, for the corresponding guide on the basis of the event information and letting an operator judge and execute the detected guide (a selected guide).

Incidentally, PTL 1 indicated below as an invention related to the countermeasure upon the occurrence of the event discloses, for example, a monitoring system which enables an administrator to appropriately deal with alarm information output from a monitoring target apparatus.

Specifically speaking, PTL 1 discloses, for example, a monitoring system that: divides a plurality of pieces of learning alarm information into a plurality of elements by using definition data in which a learning importance degree indicating a degree of necessity to take a countermeasure is associated with each learning alarm information; provides a learning device which outputs an estimated importance degree estimated for active alarm information, which is different from the plurality of pieces of the learning alarm information, on the basis of the relation between the plurality of the divided elements and the learning importance degree corresponding to each of the plurality of pieces of the learning alarm information; inputs alarm information output from each of a plurality of monitoring target apparatuses, as the active alarm information, to the learning device; and, if the estimated importance degree output from the learning device is equal to or larger than a threshold value, outputs a procedure manual indicating a countermeasure procedure for the alarm information.

### CITATION LIST

### Patent Literature

PTL 1: Japanese Patent Application Laid-Open (Kokai) Publication No. 2018-170027

### SUMMARY OF THE INVENTION

### Problems to be Solved by the Invention

Meanwhile, in recent years, there has been an increase in demand for automatic execution of a countermeasure(s) against an event(s) from the viewpoint of cost reduction of maintenance and management work and expediting of the countermeasure(s). In this case, simple countermeasures such as informing a registered person in charge of the occurrence of an event and collecting information about the occurred event can be relatively easily automated. However, regarding countermeasures which would cause a wide range of influences when being executed, such as restart of a host or an application, reconnection of a VPN (Virtual Private Network) session, and release of a memory cache, such countermeasures have a significant influence on a user's work when they fail, so that there is a problem of difficulty in automatically judging whether to execute them immediately or not.

The present invention was devised in consideration of the above-described circumstances and aims at proposing an information processing system, method, and apparatus capable of reducing costs of the maintenance and management work and expediting the countermeasure(s).

### Means to Solve the Problems

In order to solve the above-described problems, there is provided according to the present invention an information processing system for executing a countermeasure or countermeasures against a new event which has occurred at a monitoring target node, wherein the information processing system includes: a guide selection unit that allocates a guide for the new event on the basis of event information transmitted from the monitoring target node at which the new event has occurred; a judgment unit that judges whether or not a countermeasure designated by the guide selected for the new event by the guide selection unit can be executed; and a countermeasure execution unit that executes the countermeasure if the judgment unit obtains a judgment result that the countermeasure should be executed, wherein the judgment unit: identifies past events which have high similarity to the new event which has occurred at the monitoring target node; and judges that the countermeasure designated by the guide selected by the guide selection unit should be executed if the countermeasures against a specified last number of the past events among the identified past events have been successful and the countermeasure against the past event which is the latest and is more similar to the new event among the past events identified as the new event has been successful.

Moreover, there is provided according to the present invention an information processing method executed in an information processing system for executing a countermeasure or countermeasures against a new event which has occurred at a monitoring target node, wherein the information processing method includes: a first step of selecting a guide for the new event on the basis of event information transmitted from the monitoring target node at which the new event has occurred; a second step of judging whether or not a countermeasure designated by the guide selected for the new event can be executed; and a third step of executing the countermeasure if a judgment result is obtained that the countermeasure should be executed, wherein in the second step: past events which have high similarity to the new event which has occurred at the monitoring target node are identified; and it is judged that the countermeasure designated by the guide selected in the first step should be executed if the countermeasures against a specified last number of the past events among the identified past events have been successful and the countermeasure against the past event which is the latest and is more similar to the new event among the past events identified as the new event has been successful.

Furthermore, there is provided according to the present invention an information processing apparatus for executing a countermeasure or countermeasures against a new event which has occurred at a monitoring target node, wherein the information processing apparatus includes: a guide selection unit that allocates a guide for the new event on the basis of event information transmitted from the monitoring target node at which the new event has occurred; and a judgment unit that judges whether or not a countermeasure designated by the guide selected for the new event by the guide selection unit can be executed, wherein the judgment unit: identifies past events which have high similarity to the new event which has occurred at the monitoring target node; and judges that the countermeasure designated by the guide selected by the guide selection unit should be executed if the countermeasures against a specified last number of the past events among the identified past events have been successful and the countermeasure against the latest past event which is the latest and is more similar to the new event among the past events identified as the new event has been successful.

When the information processing system, method, and apparatus according to the present invention are employed, whether it is possible to execute a countermeasure against a new event or not can be judged in consideration of past actual countermeasure results; and, therefore, it is possible to automatically selectively execute a countermeasure which may highly possibly be successful. Therefore, it is possible to expand the range of events regarding which the countermeasure(s) can be automatically executed by the information processing system, while reducing risks at the time of a failure of the countermeasure(s).

### Advantageous Effects of the Invention

According to the present invention, it is possible to implement the information processing system, method, and apparatus capable of reducing the costs of the maintenance and management work and expediting the countermeasure(s).

### BRIEF DESCRIPTION OF DRAWINGS

FIG. 1 is a block diagram illustrating a hardware configuration of an information processing system according to this embodiment;

FIG. 2 is a block diagram illustrating a logical configuration of the information processing system according to this embodiment;

FIG. 3 is a chart illustrating a configuration example of an event database;

FIG. 4 is a chart illustrating a configuration example of a configuration information database;

FIG. 5 is a chart illustrating a configuration example of a guide database;

FIG. 6 is a chart illustrating a configuration example of an event history database;

FIG. 7 is a chart illustrating a configuration example of a countermeasure execution database;

FIG. 8 is a diagram illustrating a screen configuration example of an event list screen;

FIG. 9 is a diagram illustrating a screen configuration example of an event details screen; and

FIG. 10 is a flowchart illustrating a processing sequence of automatic execution possibility judgment processing.

### DESCRIPTION OF EMBODIMENTS

An embodiment of the present invention will be described below in detail with reference to the drawings.

### (1) Configuration of Information Processing System According to This Embodiment

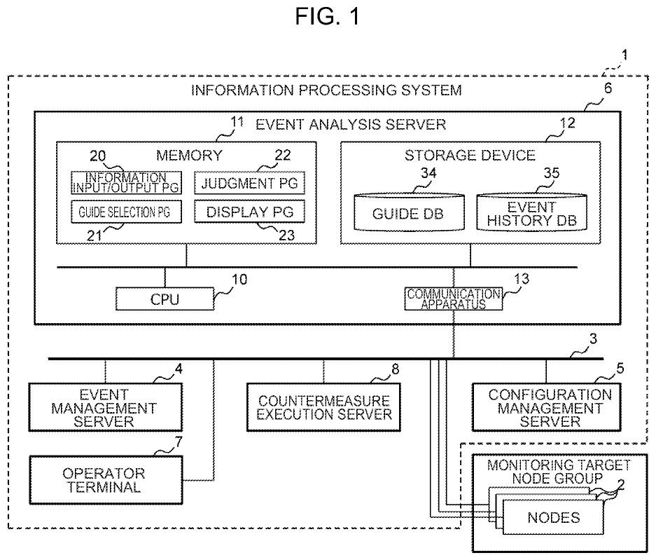

Referring to FIG. 1, the reference numeral 1 represents an information processing system according to this embodiment as a whole. This information processing system 1 is a system having a function that: judges whether or not it is possible to execute the corresponding countermeasure on the basis of event information transmitted from the relevant monitoring target node 2 if a new event (hereinafter referred to as the “new event”) occurs at each equipment which is a monitoring target such as a server apparatus or a storage apparatus (hereinafter referred to as a “monitoring target node”); and automatically executes the countermeasure if it is possible to execute the countermeasure.

This information processing system 1 is configured by including an event management server 4, a configuration management server 5, an event analysis server 6, an operator terminal 7, and a countermeasure execution server 8 which are coupled to each other via a network 3 such as a LAN (Local Area Network) or a WAN (Wide Area Network). Each monitoring target node is also coupled to the network 3.

The event management server 4 is a general-purpose server apparatus having a function that manages the event information of the new event which is transmitted from the monitoring target node 2. Furthermore, the configuration management server 5 is a general-purpose server apparatus having a function that manages the respective monitoring target nodes 2 and configuration information of respective systems configured by these monitoring target nodes 2.

The operator terminal 7 is an operation terminal for an operator, which has a function that allows the operator to issue various instructions to the event analysis server 6 and displays a screen based on screen data transmitted from the event analysis server 6. Furthermore, the countermeasure execution server 8 is a general-purpose server apparatus equipped with a function that executes a countermeasure designated for a designated monitoring target node 2 in accordance with a countermeasure execution instruction described later and issued from the event analysis server 6.

The event analysis server 6 is a server apparatus having a function that judges whether a countermeasure against the relevant new event should be automatically executed or not, on the basis of the event information of the new event managed by the event management server 4. If the event analysis server 6 obtains a judgment that the relevant countermeasure should be automatically executed, it issues an instruction to the countermeasure execution server 8 that the countermeasure should be executed (hereinafter referred to as a “countermeasure execution instruction”).

This event analysis server 6 is configured from a general-purpose server apparatus including a CPU (Central Processing Unit) 10, a memory 11, a storage device 12, and a communication apparatus 13.

The CPU 10 is a processor that integrally controls actions of the event analysis server 6. Furthermore, the memory 11 is configured from a volatile semiconductor memory such as a DRAM (Dynamic Random Access Memory) or an SRAM (Static Random Access Memory) and is used as a working memory for the CPU 10. An information input/output program 20, a guide selection program 21, a judgment program 22, and a display program 23 which will be described later are read from the storage device 12 at the time of activation of the event analysis server 6 or whenever necessary and are then stored and retained in the memory 11.

The storage device 12 is configured from a large-capacity, nonvolatile storage device such as a hard disk drive or an SSD (Solid State Drive) and is used to retain various kinds of programs, data which need to be saved for a long period of time, and so on. A guide database 34 and an event history database 35 which will be described later are also retained in this storage device 12.

The communication apparatus 13 is configured from, for example, an NIC (Network Interface Card) and performs protocol control during communication with the event management server 4, the configuration management server 5, the operator terminal 7, and the countermeasure execution server 8 via the network 3.

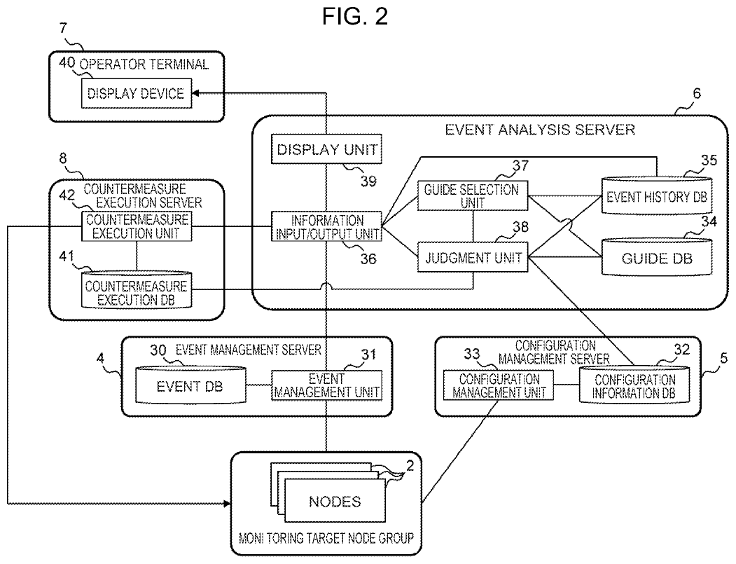

FIG. 2 illustrates a logical configuration of the information processing system 1 according to this embodiment. The event management server 4 is configured by including an event database 30 and an event management unit 31 as illustrated in this FIG. 2.

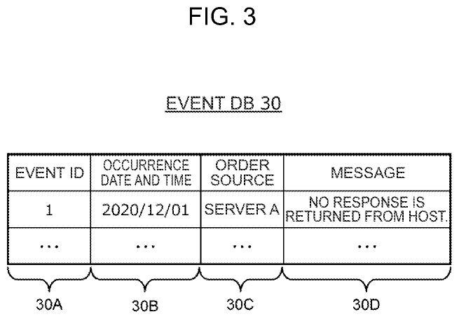

The event database 30 is a database used to manage the event information of a new event(s) transmitted from the monitoring target node 2 and has a table structure including, as illustrated in FIG. 3, an event ID column 30A, an occurrence date and time column 30B, an occurrence source column 30C, and a message column 30D. Regarding the event database 30, one row in FIG. 3 corresponds to one piece of event information transmitted from one monitoring target node 2.

Then, the event ID column 30A stores an identifier unique to the relevant new event (an event ID) which is assigned by the event management unit 31 to the relevant event information. For example, serial numbers starting from “1” are applied as the event ID. Furthermore, the occurrence date and time column 30B stores the date and time when the relevant new event occurred at the relevant monitoring target node 2.

The occurrence source column 30C stores an identifier unique to the relevant monitoring target node 2 (a node ID) which is assigned to the monitoring target node 2 where the relevant new event occurred (and which transmitted the relevant event information); and the message column 30D stores a message indicating the outline of the relevant new event included in that event information.

Accordingly, in a case of the example in FIG. 3, it is shown that: the event information to which the event ID “1” is assigned is the event information transmitted from a server with the server ID “server A,” at which a new event occurred, about the new event which occurred on “2020/12/01”; and a message included in that event information indicates “NO RESPONSE IS RETURNED FROM HOST.”

The event management unit 31 is a functional unit embodied by the execution of the relevant program mounted in the event management server 4 by a CPU, which is not illustrated in the drawing, for the event management server 4. The event management unit 31 has a function that registers and manages the event information, which is transmitted from the monitoring target node 2, in the event database 30.

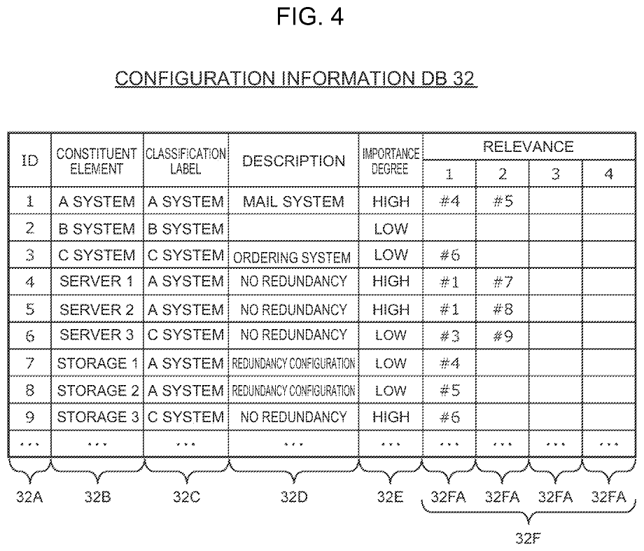

The configuration management server 5 is configured by including a configuration information database 32 and a configuration management unit 33. The configuration information database 32 is a database used to manage the configuration information of each monitoring target node 2 and is configured by including, as illustrated in FIG. 4, a constituent element ID column 32A, a constituent element column 32B, a classification label column 32C, a description column 32D, an importance degree column 32E, and a relevance column 32F. Regarding the configuration information database 32, one row in FIG. 4 corresponds to one constituent element (a monitoring target node 2 or a system configured by the monitoring target node 2).

Then, the constituent element ID column 32A stores a unique identifier in the configuration information database 32 (a constituent element ID) which is assigned to the monitoring target node 2 or the system configured by the monitoring target node 2. In a case of this embodiment, serial numbers starting from 1 are used as the constituent element ID.

Moreover, the constituent element column 32B stores the name of the relevant constituent element; and the classification label column 32C stores the name of a system configured by the relevant constituent element as a classification label of that constituent element.

Furthermore, the description column 32D stores a brief description about the relevant constituent element; and the importance degree column 32E stores an importance degree of that constituent element which is set in advance. The “importance degree” is an index for indicating the importance of the relevant constituent element. in the case of this embodiment, the above-described “importance degree” is set as three levels, “HIGH,” “MEDIUM,” and “LOW” in descending order of the importance.

Furthermore, the relevance column 32F is divided into a plurality of divided columns 32FA and a necessary number of divided columns 32FA among these divided columns 32FA store the constituent element ID(s) of a constituent element(s) having relevance to the relevant constituent element(s). Incidentally, the expression “the constituent element(s) having relevance to . . . ” used herein: corresponds to a monitoring target node 2 such as a server or a storage which configures a system if “the relevant constituent element” is the system; and corresponds to the system configured by the monitoring target node 2 if “the relevant constituent element” is the monitoring target node 2.

Accordingly, in a case of the example in FIG. 4, it is shown that: a constituent element to which the constituent element ID “4” is assigned is a monitoring target node 2 which is “SERVER 1” belonging to “A SYSTEM” (i.e., which configures “A SYSTEM”); this “SERVER 1” is not made redundant (“NO REDUNDANCY”); its importance degree is set as “HIGH”; and “A SYSTEM” (“#1”) to which this “SERVER 1” belongs, and “STORAGE 1” which, together with “SERVER 1,” configures “A SYSTEM” are registered as constituent elements having the relevance.

The configuration management unit 33 is a functional unit embodied by the execution of the relevant program mounted in the configuration management server 5 by a CPU, which is not illustrated in the drawing, for the configuration management server 5. The configuration management unit 33 has a function that collects configuration information about the relevant monitoring target node 2 from each monitoring target node 2 and registers and manages the collected configuration information in the configuration information database 32.

Meanwhile, the event analysis server 6 is configured by including a guide database 34 and an event history database 35, an information input/output unit 36, a guide selection unit 37, a judgment unit 38, and a display unit 39.

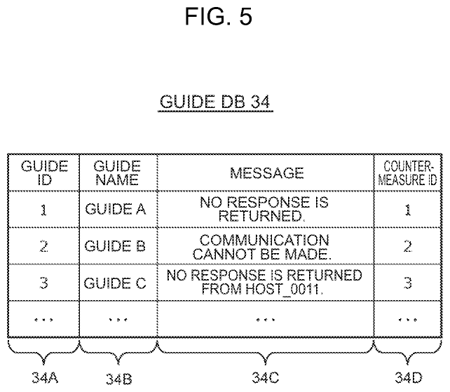

The guide database 34: is a database in which guide information of various kinds of guides respectively associated in advance with various kinds of messages included in the event information is registered; and has a table structure including, as illustrated in FIG. 5, a guide ID column 34A, a guide name column 34B, a message column 34C, and a countermeasure ID column 34D. Regarding the guide database 34, one row corresponds to the guide information of one guide.

Then, the message column 34C stores a message which may possibly be included in the event information; and the guide ID column 34A stores an identifier unique to the relevant guide (a guide ID) which is assigned to the guide associated with that message. Moreover, the guide name column 34B stores the name of the relevant guide (a guide name); and the countermeasure ID column 34D stores an identifier which is unique to the relevant countermeasure and is assigned to the countermeasure associated with that guide (a countermeasure ID).

Accordingly, in a case of the example in FIG. 5, it is shown that: a guide called “GUIDE A” to which the guide ID “1” is assigned is a guide corresponding to a message reciting “NO RESPONSE IS RETURNED” which is included in the event information; and this guide is associated with a countermeasure to which the countermeasure ID “1” is assigned.

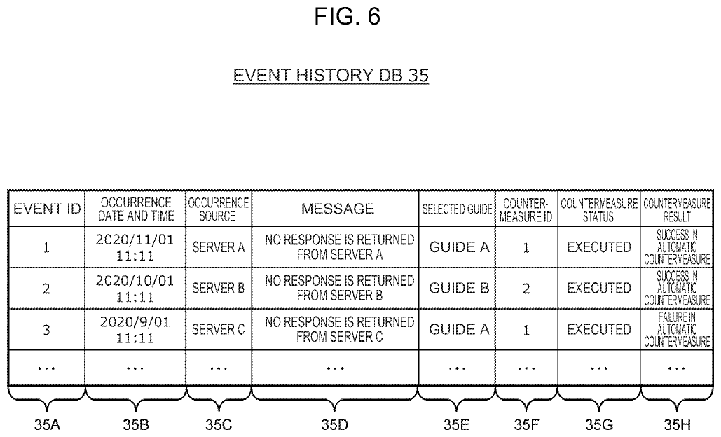

The event history database 35: is a database to which all pieces of the event information stored in the event database 30 for the event management server 4, including the event information regarding which the countermeasure execution has been completed, is copied; and is configured by including, as illustrated in FIG. 6, an event ID column 35A, an occurrence date and time column 35B, an occurrence source column 35C, a message column 35D, a selected guide column 35E, a countermeasure ID column 35F, a countermeasure status column 35G, and a countermeasure result column 35H. Regarding the event history database 35, one row in FIG. 6 corresponds to one piece of the event information.

Then, the event ID column 35A, the occurrence date and time column 35B, the occurrence source column 35C, and the message column 35D respectively store the same information as the information respectively stored in the event ID column 30A, the occurrence date and time column 30B, the occurrence source column 30C, and the message column 30D in the relevant raw of the event database 30 described earlier with reference to FIG. 3.

Moreover, the selected guide column 35E stores a guide name of a guide selected for the relevant event; and the countermeasure execution ID column 35F stores a countermeasure ID of a countermeasure executed for that event.

Furthermore, the countermeasure status column 35G stores a current countermeasure execution status of the relevant event. The above-described execution status include: “EXECUTED” meaning that the countermeasure has already been completed; “BEING EXECUTED” meaning that the countermeasure is currently being executed; and “UNEXECUTED” meaning that the countermeasure has not been executed yet for whatever reason.

Furthermore, when the execution of a countermeasure against the relevant event has been completed, the countermeasure result column 35H stores the execution result. As the countermeasure execution result, there are: a “SUCCESS IN AUTOMATIC COUNTERMEASURE” meaning that the automatically executed countermeasure has been successful; a “FAILURE IN AUTOMATIC COUNTERMEASURE” meaning that the automatically executed countermeasure has failed; a “SUCCESS IN MANUAL EXECUTION” meaning that the countermeasure manually executed by the operator has been successful; and a “FAILURE IN IN MANUAL EXECUTION” meaning that the countermeasure manually executed by the operator has failed.

Accordingly, in a case of the example in FIG. 6, it is shown that the guide name of a guide selected for an event to which the event ID “1” is assigned is “GUIDE A”; a countermeasure to which the countermeasure ID “1” is assigned based on this “GUIDE A” was automatically executed and was completed (“EXECUTED”); and its execution result was a “SUCCESS IN AUTOMATIC COUNTERMEASURE.”

The information input/output unit 36 is a functional unit embodied by the execution of the information input/output program 20 (FIG. 1) mounted in the memory for the event analysis server 6 (FIG. 11) by the CPU 10 (FIG. 1). The information input/output unit 36 has a function that regularly (for example, once in one minute) communicates with the event management server 4, acquires the event information of new events (new events) accumulated in the event database 30 via the event management unit 31, and stores the acquired event information in the event history database 35. When the event information of a new event is stored in the event history database 35, the information input/output unit 36 outputs a notice to that effect including the event ID of the new event (hereinafter referred to as a “new event registration notice”) to the guide selection unit 37 and the judgment unit 38.

Moreover, the information input/output unit 36 also has a function that transfers the aforementioned countermeasure execution instruction, which was issued from the judgment unit 38, to the countermeasure execution server 8 via the network 3 (FIG. 1) and transfers screen data of various kinds of screens, which are given from the judgment unit 38 and will be described later, to the display unit 39.

The guide selection unit 37 is a functional unit embodied by the execution of the guide selection program 21 (FIG. 1), which is stored in the memory 11 for the event analysis server 6 (FIG. 11), by the CPU 10 (FIG. 1). When the aforementioned new event registration notice is given from the information input/output unit 36, the guide selection unit 37 has a function that searches for a guide corresponding to the new event and notifies the judgment unit 38 of the guide ID of the detected guide.

Practically, the guide selection unit 37 searches the event history database 35 for the event information of the new event on the basis of the event ID included in the new event registration notice given from the information input/output unit 36 and acquires a message and occurrence source information included in the event information of the detected new event from the event history database 35.

Moreover, the guide selection unit 37 searches the guide database 34 for a guide for the new event on the basis of the acquired message and occurrence source information. Then, the guide selection unit 37 notifies the judgment unit 38 of the guide ID of the guide detected by this search as a selected guide for the new event.

The judgment unit 38 is a functional unit embodied by the execution of the judgment program 22 (FIG. 1), which is stored in the memory 11 for the event analysis server 6, by the CPU 10. The judgment unit 38 has a function that: judges whether a countermeasure with the countermeasure ID designated by the guide to which the guide ID of the selected guide for the new event reported from the guide selection unit 37 is assigned should be automatically executed or not, on the basis of the above-described guide ID of the selected guide and new event registration information given from the information input/output unit 36; and executes processing according to the judgment result.

Practically, the judgment unit 38 acquires the guide information of the selected guide from the guide database 34 on the basis of the guide ID of the selected guide reported from the guide selection unit 37. Moreover, the judgment unit 38 acquires the message included in the event information of the new event from the event history database 35 on the basis of the new event registration information given from the information input/output unit 36.

Then, the judgment unit 38 judges whether or not the message included in the guide information of the selected guide selected for the new event which is acquired as explained above matches the message included in the new event. Then, if these messages match each other, the judgment unit 38: decides that the countermeasure designated by the selected guide should be executed; and sends a countermeasure execution instruction, including the countermeasure ID of that countermeasure, to the countermeasure execution server 8 via the information input/output unit 36 (rule-based automatic execution).

On the other hand, if the message included in the guide information of the selected guide does not match the message included in the event information of the new event, the judgment unit 38 identifies past events which are similar to the new event from among past events registered in the event history database 35 (FIG. 6) (hereinafter referred to as the “past events”).

Specifically speaking, the judgment unit 38 identifies, as the new event, all the past events with metrics having high similarity (hereinafter referred to as “similar past events”) to metrics (which are assumed here as the “message,” the “occurrence source,” and the “classification label”) included in the event information of the new event from among the past events registered in the event history database 35.

Then, if certain conditions are satisfied, for example, if countermeasures for a specified last number of the similar past events among the identified similar past events have been successful and past events which are more similar to the new event (and which are the similar past events whose “occurrence source” matches that of the new event in this example and which will be hereinafter referred to as “highly similar past events”) exist among the past events identified as the new event, and a countermeasure against the latest highly similar past event has been successful, the judgment unit 38 judges that the countermeasure designated by the selected guide for the new event should be automatically executed. Then, in this case, the judgment unit 38 generates a countermeasure execution instruction including the countermeasure ID of the counter measure designated by the selected guide for the new event and transmits the generated countermeasure execution instruction to the countermeasure execution server 8 via the information input/output unit 36.

Furthermore, if such certain conditions are not satisfied, the judgment unit 38: judges that the operator should manually execute the counter measure designated by the selected guide for the new event; and outputs the event information of the new event and information of the selected guide for the new event to the display unit 39 via the information input/output unit 36.

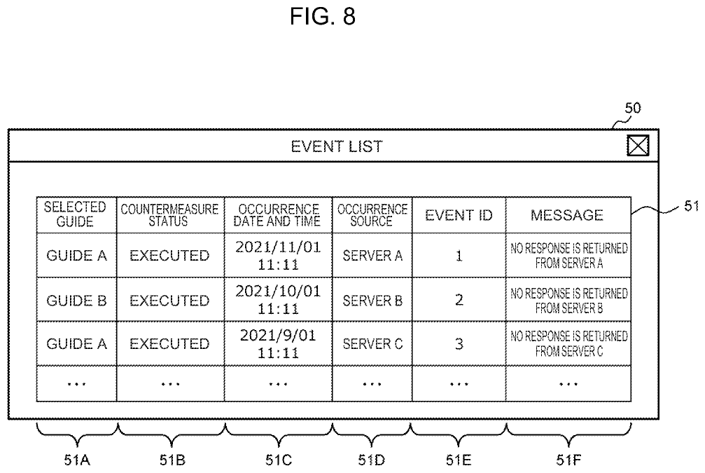

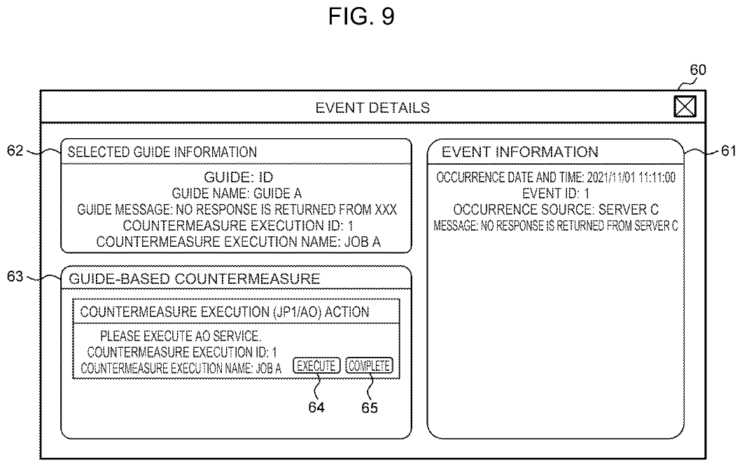

The display unit 39 is a functional unit embodied by the execution of the display program 23 (FIG. 1), which is stored in the memory 11 for the event analysis server 6, by the CPU 10. The display unit 39 generates an event list screen 50 described later with respect to FIG. 8 and an event details screen 60 described later with respect to FIG. 9 on the basis of the aforementioned various kinds of information given from the judgment unit 38 via the information input/output unit 36 and transmits screen data of these generated screens to the operator terminal 7 as appropriate. As a result, the event list screen 50 and the event details screen 60 are displayed on a display device 40 for the operator terminal 7.

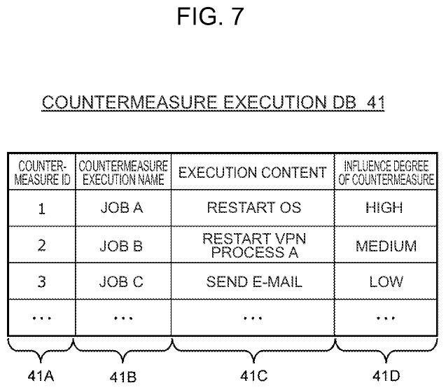

On the other hand, the countermeasure execution server 8 is configured by including a countermeasure execution database 41 and a countermeasure execution unit 42. The countermeasure execution database 41 is a database for managing the specific content of various kinds of countermeasures which are registered in advance, and has a table structure including, as illustrated in FIG. 7, a countermeasure ID column 41A, a countermeasure execution name column 41B, an execution content column 41C, and an influence-degree-of-countermeasure column 41D. Regarding the countermeasure execution database 41, one row in FIG. 7 corresponds to one countermeasure.

Then, the countermeasure ID column 41A stores the countermeasure ID of the relevant countermeasure; and the countermeasure execution name column 41B stores a job name of a job which should be executed as the relevant countermeasure. Moreover, the execution content column 41C stores specific execution content of the relevant job.

Furthermore, the influence-degree-of-countermeasure column 41D stores an influence degree of the relevant countermeasure. The “influence degree” is an index indicating the size of the influence caused by the relevant countermeasure on the user's work. In the case of this embodiment, the above-described “influence degree” is set to have three levels of “HIGH,” “MEDIUM,” and “LOW” sequentially in descending order of the influence.

Accordingly, in a case of the example in FIG. 7, it is shown that: a countermeasure to which the countermeasure ID “1” is assigned is to execute a job whose countermeasure name is “JOB A” with the processing content to “RESTART OS”; and the influence degree to affect the user's work is “HIGH.”

The countermeasure execution unit 42 is a functional unit embodied by the execution of the relevant program, which is mounted in the countermeasure execution server 8, by a CPU which is not illustrated in the drawing. When the countermeasure execution instruction is given from the judgment unit 38 for the event analysis server 6, the countermeasure execution unit 42 has a function that executes a countermeasure designated by that countermeasure execution instruction.

Practically, when such countermeasure execution instruction is given, the countermeasure execution unit 42 extracts the countermeasure ID from the countermeasure execution instruction and extracts information about the countermeasure to which the extracted countermeasure ID is assigned (hereinafter referred to as “countermeasure information”) from the countermeasure execution database 41. Then, the countermeasure execution unit 42 executes the countermeasure on the basis of the extracted countermeasure information.

### (2) Configurations of Various Kinds of Screens

FIG. 8 illustrates the configuration of the event list screen 50 displayed on the display device 40 for the operator terminal 7 by the display unit 39 on the basis of the screen data given from the judgment unit 38 for the event analysis server 6 to the display unit 39 via the information input/output unit 36 as described above.

This event list screen 50: is a screen used to display various kinds of information about each new event judged by the judgment unit 38 that the operator should manually execute the countermeasure; and is configured by including an event list 51.

The event list 51 is configured by including a selected guide column 51A, a countermeasure status column 51B, an occurrence date and time column 51C, an occurrence source column 51D, an event ID column 51E, and a message column 51F. Regarding the event list 51, one row corresponds to one new event judged by the judgment unit 38 that the operator should manually execute a countermeasure.

Then, the selected guide column 51A, the countermeasure status column 51B, the occurrence date and time column 51C, the occurrence source column 51D, the event ID column 51E, and the message column 51F respectively display the same information as the information stored in the selected guide column 35E, the countermeasure status column 35G, the occurrence date and time column 35B, the occurrence source column 35C, the event ID column 35A, and the message column 35D of a row corresponding to the relevant new event in the event history database 35 (FIG. 6).

Meanwhile, by double-clicking a row corresponding to a desired new event among the respective rows of the event list 51 in the event list screen 50 and thereby selecting the new event, the event details screen 60 as illustrated in FIG. 9 can be displayed on the operator terminal 7 instead of the event list screen 50 or so as to overlay the event details screen 60 over the event list screen 50.

This event details screen 60 is a screen used to display detailed information of a new event selected on the event list screen 50 as described above (hereinafter referred to as a “selected new event”) and is configured by including an event information display area 61, a selected guide information display area 62, and a countermeasure execution/completion designating area 63.

Then, the event information display area 61 displays the event information of the selected new event. Specifically speaking, the occurrence date and time of the selected new event, the event ID, the occurrence source, and the message included in the event information of the selected new event are displayed as such event information.

Moreover, the selected guide information display area 62 displays the guide information of a guide selected by the guide selection unit 37 for the event analysis server 6 for the selected new event. Specifically speaking, the guide ID, the guide name, the message, the countermeasure ID, and the countermeasure name of the above-mentioned guide are displayed as the above-mentioned guide information.

Furthermore, the countermeasure execution/completion designating area 63 displays the countermeasure ID and the countermeasure name, which are designated by the guide whose guide information is displayed in the selected guide information display area 62, as well as an execute button 64 and a complete button 65.

Then, the operator can execute a countermeasure corresponding to the countermeasure ID displayed in the countermeasure execution/completion designating area 63 as a countermeasure against the selected new event by clicking the execute button 64. In this case, this event details screen 60 is closed at the timing when the execute button 64 is clicked.

Moreover, for example, if the above-mentioned countermeasure has a problem, the operator can close this event details screen 60 without executing the countermeasure by clicking the complete button 65. In this case, the operator thinks that the countermeasure designated by the selected guide selected by the guide selection unit 37 for the event analysis server 6 is inappropriate as the countermeasure against the selected new event, so that subsequently, measures such as an update of the guide selection program 21 (FIG. 1) will be taken.

### (3) Automatic Execution Possibility Judgment Processing

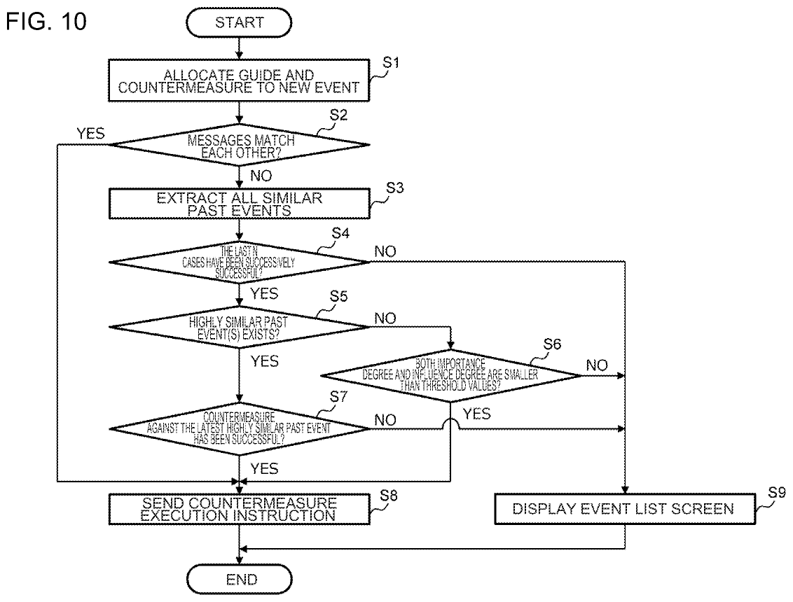

FIG. 10 illustrates a series of processing flows of judging whether or not it is possible to automatically execute a countermeasure against the new event, which will be executed by the guide selection unit 37 and the judgment unit 38 for the event analysis server 6. After receiving a notice from the information input/output unit 36 that the event information of the new event is registered in the event history database 35 (a new event registration notice), the guide selection unit 37 and the judgment unit 38 judge whether or not to automatically execute the countermeasure against the new event, in accordance with the processing sequence illustrated in this FIG. 10.

Practically, once the new event registration notice is given from the information input/output unit 36 to the guide selection unit 37 and the judgment unit 38, this automatic execution possibility judgment processing is started and the guide selection unit 37 firstly reads the event information from the event history database 35. Moreover, the guide selection unit 37 allocates a guide corresponding to the new event by referring to the guide database 34 (FIG. 5) on the basis of the message included in the read event information and notifies the judgment unit 38 of the guide ID of the selected guide (the selected guide for the new event) (S1).

After being notified of the guide ID by the guide selection unit 37, the judgment unit 38 acquires the guide information of the selected guide, to which that guide ID is assigned, from the guide database 34. Moreover, the judgment unit 38 acquires the message included in the event information of the new event from the event history database 35 on the basis of the new event registration information given from the information input/output unit 36. Then, the judgment unit 38 judges whether or not the message acquired as described above and included in the guide information of the selected guide selected for the new event matches the message included in the new event (S2).

If the judgment unit 38 obtains an affirmative result in this judgment, the judgment unit 38: decides that the countermeasure designated by the selected guide should be automatically executed; and transmits a countermeasure execution instruction including the countermeasure ID of the countermeasure to the countermeasure execution server 8 via the information input/output unit 36 (S8). As a result, the above-described countermeasure is automatically executed by the countermeasure execution server 8 in accordance with this countermeasure execution instruction. As a result, this series of processing terminates.

On the other hand, if the judgment unit 38 obtains a negative result in the judgment of step S2, the judgment unit 38 extracts past events having high similarity to the new events (similar past events) from among the past events registered in the event history database 35 (S3).

Specifically speaking, the judgment unit 38 firstly performs word parsing by breaking up each of the message and the occurrence source, which are included in the event information of the new event, and the classification label of the occurrence source into words by means of morphological analysis. Moreover, the judgment unit 38 extracts all past events, regarding which the same guide as that of the selected guide of the new event and with the same designated countermeasure ID is selected, from among the respective past events registered in the event history database 35 and performs word parsing by breaking up messages and occurrence sources, which are included in the event information of these past events, and classification labels of the occurrence sources into words by means of morphological analysis. When this happens, the judgment unit 38 reads and acquires the classification labels of the new event and the respective past events, which are extracted from the event history database 35, from the configuration information database 32 via the configuration management unit 33 for the configuration management server 5.

Then, the judgment unit 38 calculates the similarly between the message, the occurrence source, and the classification label of the new event regarding which the word parsing was conducted as described above, and the message, the occurrence source, and the classification label of each past event extracted from the event history database 35 (a word matching rate in this example) with respect to each of the message, the occurrence source, and the classification label.

Subsequently, the judgment unit 38 calculates a score of each past event extracted from the event history database 35 according to the following expression on the basis of the above-calculated similarity of the occurrence source, the message, and the classification label between the new event and each past event extracted from the event history database 35.

[Math. 1]

Score=(Similarity of Occurrence Source)×w1+(Similarity of Message)×w2+(Similarity of Classification Label)×w3 (1)

Incidentally, w1, w2, and w3 in Expression (1) respectively represent weights for the “Similarity of Occurrence Source,” “Similarity of Message,” and the “Similarity of Classification Label” and are set in advance so that the range of the above-calculated score falls within the range of 0 to 1.

Then, the judgment unit 38 recognizes all the past events, regarding which the thus-calculated score is larger than a preset threshold value (for example, 0.7), as the aforementioned similar past events and extracts information of each of the similar past events from the event history database 35.

Next, the judgment unit 38 judges whether all countermeasures against the last consecutive n pieces (where n is a preset positive number, for example, “2”) of the similar past events, among the similar past events extracted in step S3, have been successful or not (S4). This judgment can be made by referring to the countermeasure result of the relevant similar past event (the countermeasure result stored in the countermeasure result column 35H in FIG. 6) with respect to each of the n pieces of the similar past events.

To obtain the negative result in this judgment means that no similar past event exists or, even if the similar past event(s) exists, the countermeasures against the last n pieces of the similar past events have not been successively successful. Therefore, under this circumstance, the judgment unit 38: outputs the event information of the new event and the guide information of the selected guide for that new event to the display unit 39 via the information input/output unit 36 and thereby causes the event list screen 50 described earlier with reference to FIG. 8 to be displayed on the display device 40 (FIG. 2) for the operator terminal 7 (FIG. 2) (S9); and then terminates this series of processing.

On the other hand, if the judgment unit 38 obtains an affirmative result in the judgment of step S4, the judgment unit 38 judges whether or not any similar past event having higher similarity to the new event exists among the similar past events extracted in step S3 (S5). This judgment is made by judging whether or any similar past event with the occurrence source which matches the occurrence source of the new event exists among the similar past events extracted in step S3.

If the judgment unit 38 obtains a negative result in this judgment, the judgment unit 38 acquires the importance degree of the occurrence source of the new event from the configuration information database 32 of the configuration management server 5 and also acquires the influence degree of the countermeasure designated by the guide selected for the new event (the selected guide) form the countermeasure execution database 41 of the countermeasure execution server 8. Then, the judgment unit 38 judges whether or not the importance degree of the monitoring target node 2 at which the new event has occurred is smaller than a first threshold value which is preset for the importance degree (the importance degree <the first threshold value) and the influence degree of the countermeasure designated by the selected guide is smaller than a second threshold value which is preset for the influence degree (the influence degree <the second threshold value) (S6).

To obtain an affirmative result in this judgment means that even if both the importance degree of the occurrence source of the new event and the influence degree of the countermeasure are small and the countermeasure against the new event has failed, it will not have any significant influence on the user's work which uses the monitoring target node 2 at which the new event occurred. Therefore, when this happens, the judgment unit 38 transmits a countermeasure execution instruction, including the countermeasure ID of the countermeasure designated by the guide (the selected guide) selected for the new event by the guide selection unit 37, to the countermeasure execution server 8 via the information input/output unit 36 (S8), and then terminates this series of processing. As a result, that countermeasure is executed by the countermeasure execution server 8.

On the other hand, to obtain a negative result in the judgment of step S6 means that if at least one of the importance degree of the occurrence source of the new event and the influence degree of the countermeasure is large and the countermeasure against the new event has failed, there is fear that it may possibly have the significant influence on the user's work which uses the monitoring target node 2 at which the new event occurred. Therefore, when this happens, the judgment unit 38 executes the processing explained above with regard to step S9 (S9) and then terminates this series of processing.

On the other hand, if the judgment unit 38 obtains an affirmative result in the judgment of step S5, the judgment unit 38 judges, on the basis of the event information of the latest highly similar past even detected in step S5, whether a countermeasure against such highly similar past event has been successful or not (S7).

Then, if the judgment unit 38 obtains a negative result in this judgment, the judgment unit 38 executes the processing described above with respect to step S8 (S8) and then terminates this series of processing. Moreover, if the judgment unit 38 obtains an affirmative result in the judgment of step S7, the judgment unit 38 executes the processing described above with respect to step S9 (S9) and then terminates this series of processing.

### (4) Advantageous Effects of This Embodiment

Regarding the information processing system 1 according to this embodiment as described above, the judgment unit 38 for the event analysis server 6: identifies past events similar to a new event which has occurred at the monitoring target node 2; and judges that a countermeasure designated by a guide selected for the new event by the guide selection unit 37 should be executed if countermeasures against a specified last number of the similar past events (the similar past events), among the identified past events, have been successful and a countermeasure against the latest highly similar past event among the similar past events has been successful.

Consequently, according to this information processing system 1, whether the countermeasure against the new event can be executed or not can be judged in consideration of actual countermeasure results in the past, so that it is possible to selectively automatically execute a countermeasure which is highly likely to be successful. As a result, the range of events against which countermeasures are automatically executed by the information processing system can be expanded, while reducing the risk of failures of the countermeasures; and, therefore, it is possible to aim at the cost reduction of the maintenance and management work and expediting of the countermeasure(s).

### (5) Other Embodiments

Incidentally, the aforementioned embodiment has described the case where the present invention is applied to the information processing system 1 configured as illustrated in FIG. 1 and FIG. 2; however, the present invention is not limited to this example and, in short, the information processing system which executes the countermeasure against the new event which has occurred at the monitoring target node can be applied to a wide variety of information processing systems with other various configurations.

For example, the information processing system may be configured so that the functions of the information input/output unit 36, the guide selection unit 37, and the judgment unit 38 which are mounted in the event analysis server 6 are distributed to, and deployed at, a plurality of computer apparatuses (server apparatuses) which are coupled to each other via a network and constitute a distributed computing system and processing similar to that of the event analysis server 6 is executed while performing communication between these computer apparatuses.

Contrarily, the event analysis server 6 may be equipped with all the respective functions of the event management unit 31 for the event management server 4, the configuration management unit 33 for the configuration management server 5, and the countermeasure execution unit 42 for the countermeasure execution server 8 and this information processing system 1 may be configured from one event analysis server 6.

Furthermore, the aforementioned embodiment has described the case where in step S4 of the automatic execution possibility judgment processing explained earlier with reference to FIG. 10, whether all the countermeasures against the last “successive n pieces” of similar past events, among the similar past events extracted in step S3, have been successful or not is judged; and if an affirmative result is obtained, the processing in step S5 and subsequent steps is executed. However, the present invention is not limited to this example and, for example, the processing in step S5 and subsequent steps may be executed if the countermeasures against n pieces of the similar past events, among the last N pieces of the similar past events, have been successful.

### INDUSTRIAL AVAILABILITY

The present invention can be applied to a wide variety of information processing systems that execute a countermeasure(s) against a new event which has occurred at a monitoring target node.

### REFERENCE SIGNS LIST

1: information processing system
2: monitoring target node
3: network
4: event management server
5: configuration management server
6: event analysis server
7: operator terminal
8: countermeasure execution server
10: CPU
20: information input/output program
21: guide selection program
22: judgment program
23: display program
30: event database
32: configuration information database
34: guide database
35: event history database
36: information input/output unit
37: guide selection unit
38: judgment unit
39: display unit
40: display device
41: countermeasure execution database
42: countermeasure execution unit
50: event list screen
60: event details screen

1. An information processing system for executing a countermeasure or countermeasures against a new event which has occurred at a monitoring target node,
the information processing system comprising:
a guide selection unit that allocates a guide for the new event on the basis of event information transmitted from the monitoring target node at which the new event has occurred;
a judgment unit that judges whether or not a countermeasure designated by the guide selected for the new event by the guide selection unit can be executed; and
a countermeasure execution unit that executes the countermeasure if the judgment unit obtains a judgment result that the countermeasure should be executed,
wherein the judgment unit:
identifies past events which have high similarity to the new event which has occurred at the monitoring target node; and
judges that the countermeasure designated by the guide selected by the guide selection unit should be executed if the countermeasures against a specified last number of the past events among the identified past events have been successful and the countermeasure against the past event which is the latest and is more similar to the new event among the past events identified as the new event has been successful.

2. The information processing system according to claim 1,
wherein the past event which is more similar to the new event is the past event having an occurrence source which is the same as an occurrence source of the new event, among the past events similar to the new event.

3. The information processing system according to claim 1,
wherein if the countermeasures against the specified last number of the past events, among the identified past events, have been successful, but the past event which is more similar to the new event does not exist among the past events identified as the new event, the judgment unit judges whether or not to execute the countermeasure designated by the guide selected for the new event by the guide selection unit, on the basis of an importance degree indicating importance of the occurrence source of the new event and an influence degree indicating a size of influence, which is caused by the countermeasure designated by the guide selected for the new event by the guide selection unit, to a user's work.

4. The information processing system according to claim 1,
wherein the judgment unit judges similarity between the new event and the past events on the basis of similarity between respective occurrence sources of the new event and the past events, messages included respectively in respective pieces of the event information of the new event and the past events, and classification labels which are formed of names of systems configured respectively from the respective occurrence sources of the new event and the past events.

5. The information processing system according to claim 1,
wherein if it is impossible to judge that the countermeasure designated by the guide selected by the guide selection unit should be executed against the new event, the judgment unit causes a specified screen to be displayed for an operator to manually execute the countermeasure against the new event.

6. An information processing method executed in an information processing system for executing a countermeasure or countermeasures against a new event which has occurred at a monitoring target node,
the information processing method comprising:
a first step of selecting a guide for the new event on the basis of event information transmitted from the monitoring target node at which the new event has occurred;
a second step of judging whether or not a countermeasure designated by the guide selected for the new event can be executed; and
a third step of executing the countermeasure if a judgment result is obtained that the countermeasure should be executed,
wherein in the second step:
past events which have high similarity to the new event which has occurred at the monitoring target node are identified; and
it is judged that the countermeasure designated by the guide selected in the first step should be executed if the countermeasures against a specified last number of the past events among the identified past events have been successful and the countermeasure against the latest past event which is the latest and is more similar to the new event among the past events identified as the new event has been successful.

7. The information processing method according to claim 6,
wherein the past event which is more similar to the new event is the past event having an occurrence source which is the same as an occurrence source of the new event, among the past events similar to the new event.

8. The information processing method according to claim 6,
wherein in the second step, if the countermeasures against the specified last number of the past events, among the identified past events, have been successful, but the past event which is more similar to the new event does not exist among the past events identified as the new event, whether or not to execute the countermeasure designated by the guide selected for the new event in the first step is judged on the basis of an importance degree indicating importance of the occurrence source of the new event and an influence degree indicating a size of influence, which is caused by the countermeasure designated by the guide selected for the new event in the first step, to a user's work.

9. The information processing method according to claim 6,
wherein in the second step, similarity between the new event and the past events is judged on the basis of similarity between respective occurrence sources of the new event and the past events, messages included respectively in respective pieces of the event information of the new event and the past events, and classification labels which are formed of names of systems configured respectively from the respective occurrence sources of the new event and the past events.

10. The information processing method according to claim 6,
wherein in the second step, if it is impossible to judge that the countermeasure designated by the guide selected in the first step should be executed against the new event, a specified screen for an operator to manually execute the countermeasure against the new event is displayed.

11. An information processing apparatus for executing a countermeasure or countermeasures against a new event which has occurred at a monitoring target node,
the information processing system comprising:
a guide selection unit that allocates a guide for the new event on the basis of event information transmitted from the monitoring target node at which the new event has occurred; and
a judgment unit that judges whether or not a countermeasure designated by the guide selected for the new event by the guide selection unit can be executed,
wherein the judgment unit:
identifies past events which have high similarity to the new event which has occurred at the monitoring target node; and
judges that the countermeasure designated by the guide selected by the guide selection unit should be executed if the countermeasures against a specified last number of the past events among the identified past events have been successful and the countermeasure against the past event which is the latest and is more similar to the new event among the past events identified as the new event has been successful.
